(19) United States
(12) Patent Application Publication
(10) Pub. No.: US 2024/0070119 A1
(43) Pub. Date: Feb. 29, 2024

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Yosuke KINOSHITA, Kanagawa (JP)

(73) Assignee: FUJIFILM Business Innovation Corp., Tokyo (JP)

(21) Appl. No.: 18/178,942

(22) Filed: Mar. 6, 2023

(30) Foreign Application Priority Data
Aug. 29, 2022 (JP) 2022-135732

(51) Int. Cl. G06F 16/17; G06F 11/30

(52) U.S. Cl. CPC G06F 16/1734; G06F 11/3034; G06F 11/3065

(57) ABSTRACT

An information processing apparatus includes a processor configured to: obtain, as log information of an operation performed on a digital file stored in a common region of the information processing apparatus, a first operation log recorded in the information processing apparatus and a second operation log recorded in a client device which has downloaded the digital file; and classify each of the obtained first operation log and second operation log as an operation log which is chronologically fixed or as an operation log which is not chronologically fixed, based on a recording time at which each of the first and second operation logs is recorded and a time at which the second operation log is obtained.

### CROSS-REFERENCE TO RELATED APPLICATIONS

This application is based on and claims priority under 35 USC 119 from Japanese Patent Application No. 2022-135732 filed Aug. 29, 2022.

### BACKGROUND

### (i) Technical Field

The present disclosure relates to an information processing apparatus and a non-transitory computer readable medium.

### (ii) Related Art

A file storage service that allows multiple client terminals to share the same digital file is available. For example, for each client terminal, a server that provides a file storage service manages operation logs of a digital file downloaded to a client terminal. As an example of managing of operation logs by a server, a technology for collecting operation logs stored in each client terminal and centrally managing them is known (see Japanese Patent No. 5768448, for example).

### SUMMARY

In this technology, a server sometimes fails to collect an operation log due to a network connection problem or malfunctioning of a client terminal, for example. This impairs the reliability of operation logs collected by the server.

Aspects of non-limiting embodiments of the present disclosure relate to making it possible to improve the reliability of operation logs collected by a server in a management system in which the server collects operation logs recorded in each client terminal and centrally manages them.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: obtain, as log information of an operation performed on a digital file stored in a common region of the information processing apparatus, a first operation log recorded in the information processing apparatus and a second operation log recorded in a client device which has downloaded the digital file; and classify each of the obtained first operation log and second operation log as an operation log which is chronologically fixed or as an operation log which is not chronologically fixed, based on a recording time at which each of the first and second operation logs is recorded and a time at which the second operation log is obtained.

### BRIEF DESCRIPTION OF THE DRAWINGS

An exemplary embodiment of the present disclosure will be described in detail based on the following figures, wherein:

FIG. 1 illustrates an example of the overall configuration of an information processing system according to the exemplary embodiment;

FIG. 2 is a block diagram illustrating an example of the hardware configuration of a management server, which serves as an information processing apparatus according to the exemplary embodiment;

FIG. 3 is a block diagram illustrating an example of the functional configuration of a controller of the management server;

FIG. 4 is a block diagram illustrating an example of the functional configuration of a controller of a user terminal;

FIGS. 5A and 5B are a flowchart illustrating an example of a procedure of processing executed by the management server from when a digital file is stored in a database of the management server until log list information is sent to the user terminal;

FIGS. 6A and 6B are a flowchart illustrating an example of a procedure of processing executed by the user terminal from when a digital file is downloaded until log list information is displayed on a user interface;

FIGS. 7A through 7E are diagrams for explaining a specific example of processing executed by the information processing system shown in FIG. 1;

FIGS. 8A through 12F are diagrams for explaining a detailed procedure of the processing shown in FIGS. 7A through 7E; and

FIG. 13 illustrates a specific example of log list information displayed on a display of the user terminal to allow a user to distinguish operation logs which are chronologically fixed and operation logs which are not chronologically fixed from each other.

### DETAILED DESCRIPTION

An exemplary embodiment of the disclosure will be described below in detail with reference to the accompanying drawings.

### (Configuration of Information Processing System)

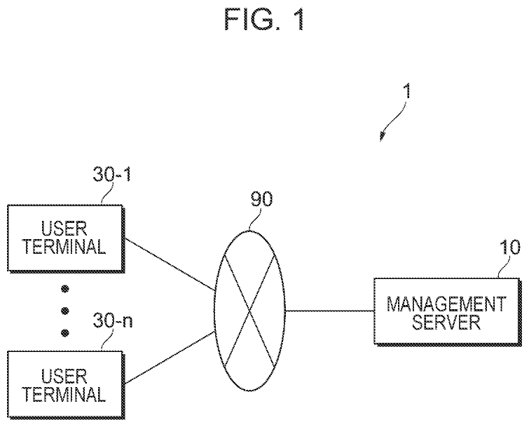

FIG. 1 illustrates an example of the overall configuration of an information processing system 1 according to the exemplary embodiment.

The information processing system 1 includes a management server 10 and user terminals 30-1 through 30-n (n is an integer of two or greater) connected to each other via a network 90. Examples of the network 90 are a local area network (LAN) and the internet. The user terminals 30-1 through 30-n will collectively be called the user terminal 30 or the user terminals 30 unless it is necessary to individually distinguish them from each other.

The management server 10 is an information processing apparatus as a server that manages the entirety of the information processing system 1. The management server 10 provides a collaboration service having a file storage function to multiple users. The management server 10 obtains an operation log which is recorded in the management server 10 as log information of an operation performed on a digital file stored in a common region of the collaboration service. Such an operation log will be called a first operation log. The management server 10 also obtains an operation log which is recorded in a user terminal 30 as log information of an operation performed by the user terminal 30 on a digital file downloaded from the common region of the collaboration service to the user terminal 30 and which is sent to the common region of the collaboration service. Such an operation log will be called a second operation log.

In the exemplary embodiment, “collaboration service” refers to a service that enables an organization of multiple users to carry out collaborative work. The collaboration service includes various functions using cloud computing, such as a file storage function, a web conferencing function, an email function, a chat function, a task management function, and a schedule management function. “Common region” is a region where multiple users can share a file.

The management server 10 classifies obtained first operation logs and second operation logs into operation logs which are chronologically fixed and operation logs which are not chronologically fixed. More specifically, the management server 10 classifies the first and second operation logs, based on the recording time at which each of the first and second operation logs is recorded and the time at which each of the second operation logs is obtained. Details of the configuration and operation of the management server 10 will be discussed later.

The user terminal 30 is an information processing apparatus operated by a user who uses the collaboration service. The user terminal 30 records, as a second operation log, log information of an operation performed on a digital file downloaded from the common region of the collaboration service. Then, among the recorded second operation logs, the user terminal 30 sends together second operation logs which have not yet been sent to the management server 10 to the common region of the collaboration service.

If an operation has not been performed on a downloaded digital file, the user terminal 30 sends, as a second operation log, log information indicating that an operation has not been performed on the digital file to the common region of the collaboration service. Sending of second operation logs is performed at a predetermined timing. Details of the configuration and operation of the user terminal 30 will be discussed later.

The above-described configuration of the information processing system 1 is only an example. The information processing system 1 may be configured in any manner if it has functions that implement the above-described processing operations as a whole. All or some of these functions may be distributed over the management server 10 and the user terminal 30 in the information processing system 1 or may be performed by the management server 10 and the user terminal 30 in collaboration with each other. That is, as discussed above, all or some of the functions of the management server 10 may be replaced by the corresponding functions of the user terminal 30. Conversely, all or some of the functions of the user terminal 30 may be replaced by the corresponding functions of the management server 10. All or some of the functions of the management server 10 and all or some of the functions of the user terminal 30 may be delegated to another device, such as another server, which is not shown. This can facilitate processing in the overall information processing system 1 and enables devices in the information processing system 1 to execute processing operations by complementing each other.

### (Hardware Configuration of Management Server)

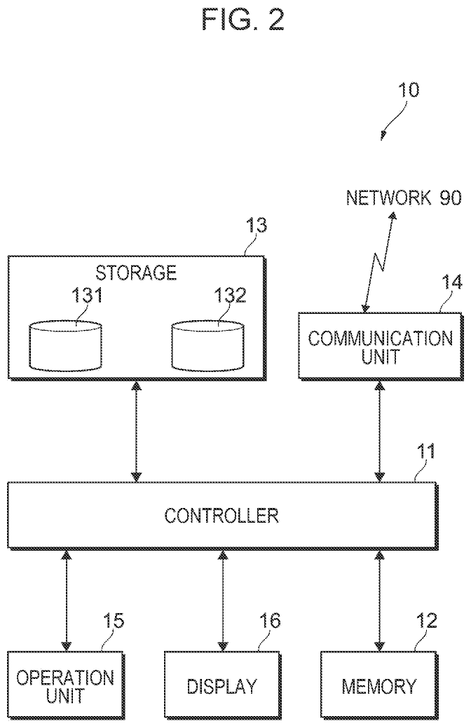

FIG. 2 is a block diagram illustrating an example of the hardware configuration of the management server 10, which serves as an information processing apparatus according to the exemplary embodiment.

The management server 10 includes a controller 11, a memory 12, a storage 13, a communication unit 14, an operation unit 15, and a display 16. These elements are connected to each other via a data bus, an address bus, and a peripheral component interconnect (PCI) bus, for example.

The controller 11 is a processor that controls the functions of the management server 10 as a result of executing various software programs, such as an operating system (OS) (basic software) and application software. The controller 11 is constituted by a central processing unit (CPU), for example. The memory 12 is a storage region for storing various software programs and data used for the execution of the software programs, and is used as a work area by the controller 11 to execute processing. The memory 12 is constituted by a random access memory (RAM), for example.

The storage 13 is a storage region for storing data to be input into various software programs and data output therefrom. The storage 13 is constituted by a hard disk drive (HDD), a solid state drive (SSD), or a semiconductor memory, for example, used for storing programs and various types of setting data. In the storage 13, a file database (DB) 131 and a log DB 132, for example, are stored as databases for storing various items of information. The file DB 131 stores a digital file. The log DB 132 stores operation logs.

The communication unit 14 sends and receives data to and from the user terminal 30 and external devices via the network 90. The operation unit 15 is constituted by a keyboard, a mouse, a mechanical button, and a switch, for example, and receives an input operation. The operation unit 15 may be a touch sensor, which integrally forms a touchscreen with the display 16. The display 16 is constituted by a liquid crystal display or an organic electroluminescence (EL) display, for example, used for displaying information, and displays image data and text data, for example.

### (Hardware Configuration of User Terminal)

The hardware configuration of the user terminal 30 is similar to that of the management server 10 shown in FIG. 2. That is, the user terminal 30 includes a controller, a memory, a storage, a communication unit, an operation unit, and a display having functions similar to the controller 11, memory 12, storage 13, communication unit 14, operation unit 15, and display 16, respectively, shown in FIG. 2. An explanation and illustration of the hardware configuration of the user terminal 30 is omitted.

### (Functional Configuration of Controller of Management Server)

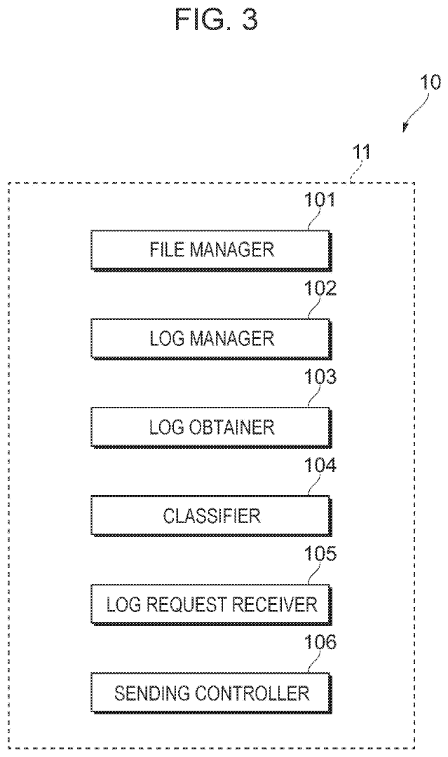

FIG. 3 is a block diagram illustrating an example of the functional configuration of the controller 11 of the management server 10.

The controller 11 of the management server 10 implements functions such as a file manager 101, a log manager 102, a log obtainer 103, a classifier 104, a log request receiver 105, and a sending controller 106.

The file manager 101 stores a digital file recorded in the common region of the collaboration service into a database and manages it. More specifically, the file manager 101 stores a digital file recorded in the common region of the collaboration service into the file DB 131 of the storage 13 (see FIG. 2) and manages it.

The log manager 102 stores first and second operation logs into a database and manages them. More specifically, the log manager 102 stores first and second operation logs into the log DB 132 of the storage 13 (see FIG. 2) and manages them.

The log obtainer 103 obtains first and second operation logs. More specifically, the log obtainer 103 obtains first operation logs managed by the log manager 102. The log obtainer 103 also obtains second operation logs sent from the user terminal 30 via the communication unit 14. Second operation logs are sent together from the user terminal 30 at a predetermined timing. More specifically, one or plural second operation logs managed by the user terminal 30 as operation logs which have not yet been sent are sent together at a predetermined timing. A second operation log sent from the user terminal 30 may include log information indicating that an operation has not been performed on a downloaded digital file in the user terminal 30.

The classifier 104 classifies the first operation logs and second operation logs obtained by the log obtainer 103. More specifically, the classifier 104 classifies the first and second operation logs into operation logs which are chronologically fixed and operation logs which are not chronologically fixed. The classifier 104 classifies the first and second operation logs, based on the recording time of each of the first and second operation logs and the time when each of the second operation logs is obtained by the log obtainer 103.

For example, the classifier 104 identifies, for each user terminal 30, the latest time at which the second operation logs have been obtained and specifies the earliest time among the identified latest times of the individual user terminals 30, based on the content of each of the second operation logs. Then, the classifier 104 classifies the operation logs whose recording times are earlier than the specified earliest time as operation logs which are chronologically fixed and which have reliably been received by the management server 10, and classifies the operation logs whose recording times are later than the specified earliest time as operation logs which are not chronologically fixed and which may have not been received by the management server 10. If there is a second operation log that the log obtainer 103 has failed to obtain among the second operation logs stored in the user terminals 30, the classifier 104 does not classify such a second operation log and handles it as an undefined operation log.

The log request receiver 105 receives information indicating a request to send information of the operation logs which are chronologically fixed and those which are not chronologically fixed to be displayed on the display of the user terminal 30 as a list. Hereinafter, information of the operation logs which are chronologically fixed and those which are not chronologically fixed will be called log list information, and information indicating a request to send the log list information will be called log request information.

The sending controller 106 performs control to send various items of information to the user terminal 30 or an external device. For example, the sending controller 106 performs control to send information indicating the presence of a second operation log that the management server 10 has failed to obtain and information indicating a request to send this second operation log to the user terminal 30. Hereinafter, information indicating the presence of a second operation log that the management server 10 has failed to obtain and information indicating a request to send this second operation log will collectively be called server unreceived operation log information. The sending controller 106 also performs control to send log list information that can be identified from the log request information received by the log request receiver 105 to the user terminal 30.

### (Functional Configuration of User Terminal)

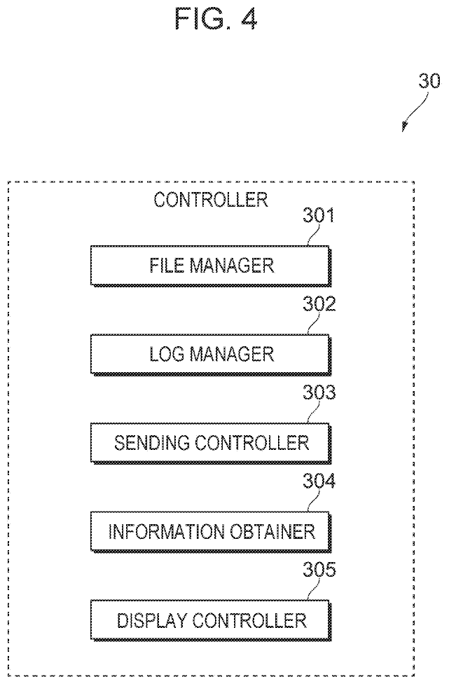

FIG. 4 is a block diagram illustrating an example of the functional configuration of the controller of the user terminal 30.

The controller of the user terminal 30 implements functions such as a file manager 301, a log manager 302, a sending controller 303, an information obtainer 304, and a display controller 305.

The file manager 301 manages a digital file downloaded from the common region of the collaboration service. More specifically, the file manager 301 obtains a digital file sent from the management server 10, stores it in a database of the storage, and manages it.

The log manager 302 records and manages second operation logs. More specifically, the log manager 302 stores second operation logs in a database of the storage of the user terminal 30 and manages them.

The sending controller 303 performs control to send various items of information to the management server 10 or an external device. More specifically, for example, the sending controller 303 performs control to send second operation logs stored in the database to the management server 10 via the communication unit and also performs control to send log request information to the management server 10.

The information obtainer 304 obtains various items of information sent from the management server 10 and an external device. More specifically, for example, the information obtainer 304 obtains server unreceived operation log information sent from the management server 10. The information obtainer 304 also obtains log list information and information input into the operation unit. An example of information input into the operation unit is log request information.

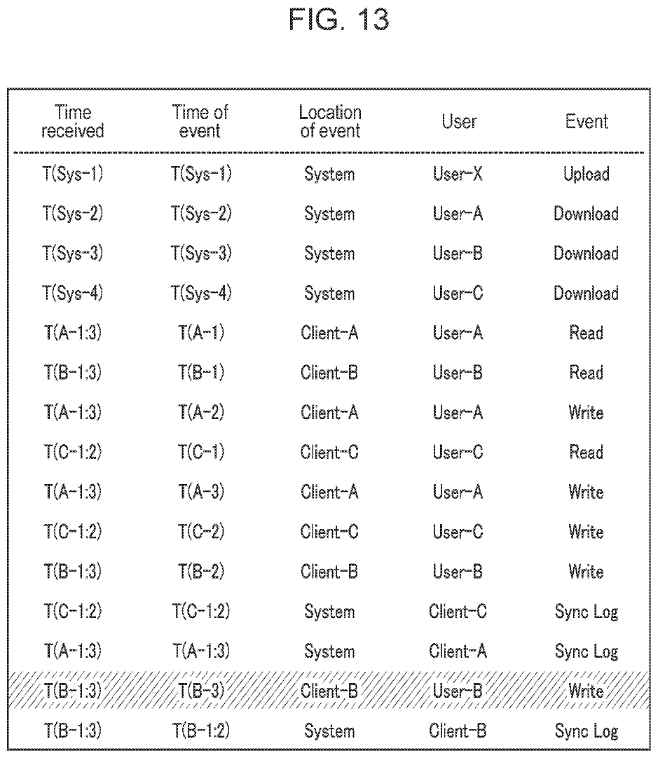

The display controller 305 performs control to display various items of information on the display. More specifically, for example, the display controller 305 performs control to display a user interface on the display. Examples of information displayed on a user interface are log list information and server unreceived operation log information. A specific example of the log list information displayed on the user interface will be discussed later in detail with reference to FIG. 13.

### (Procedure of Processing Executed by Management Server)

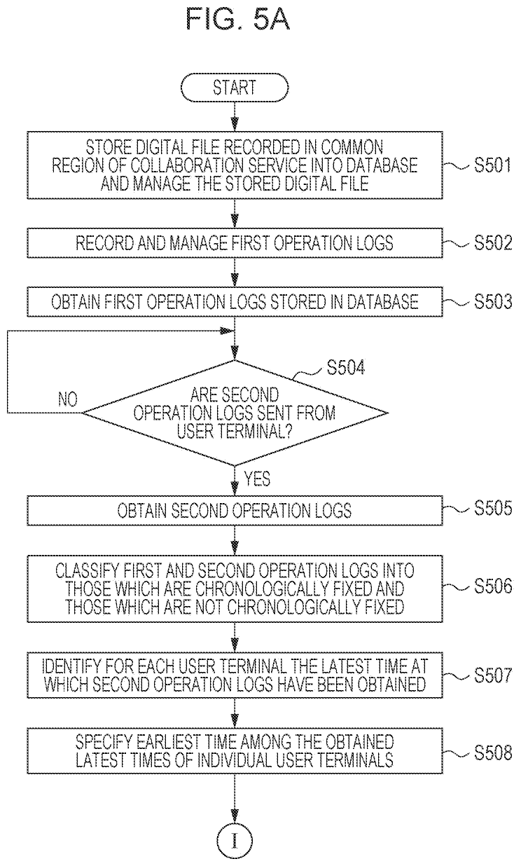

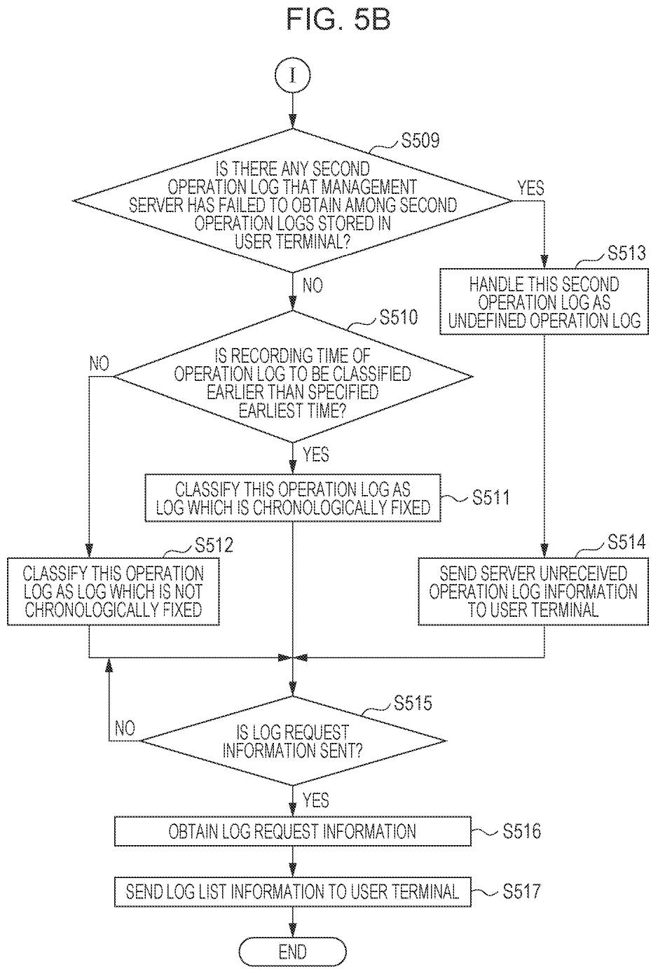

FIGS. 5A and 5B are a flowchart illustrating an example of a procedure of processing executed by the management server 10 from when a digital file is stored in a database of the management server 10 until log list information is sent to the user terminal 30.

In step S501, the management server 10 stores a digital file recorded in the common region of the collaboration service into a database and manages the stored digital file. Then, in step S502, the management server 10 records first operation logs and manages them. In step S503, the management server 10 obtains the first operation logs stored in the database.

If second operation logs are sent from the user terminal 30 (YES in step S504), the management server 10 obtains the second operation logs in step S505. If no second operation log is sent from the user terminal 30 (NO in step S504), the management server 10 repeats step S504 until second operation logs are sent from the user terminal 30.

Then, in step S506, the management server 10 classifies the first and second operation logs into operation logs which are chronologically fixed and operation logs which are not chronologically fixed. More specifically, the management server 10 classifies the first operation logs obtained in step S503 and the second operation logs obtained in step S505. Then, in step S507, based on the content of each of the second operation logs, the management server 10 identifies, for each user terminal 30, the latest time at which the second operation logs have been obtained. In step S508, the management server 10 specifies the earliest time among the identified latest times of the individual user terminals 30.

Then, if there is no second operation log that the management server 10 has failed to obtain among the second operation logs stored in the user terminal 30 (NO in step S509) and if the recording time of an operation log to be classified is earlier than the earliest time specified in step S508 (YES in step S510), the management server 10 classifies this operation log as an operation log which is chronologically fixed in step S511 and then proceeds to step S515.

If there is no second operation log that the management server 10 has failed to obtain among the second operation logs stored in the user terminal 30 (NO in step S509) and if the recording time of an operation log to be classified is later than the earliest time specified in step S508 (NO in step S510), the management server 10 classifies this operation log as an operation log which is not chronologically fixed in step S512 and then proceeds to step S515.

If there is a second operation log that the management server 10 has failed to obtain among the second operation logs stored in the user terminal 30 (YES in step S509), the management server 10 handles this second operation log as an undefined operation log in step S513. The management server 10 then sends server unreceived operation log information to the user terminal 30 in step S514 and proceeds to step S515.

If log request information is sent from the user terminal 30 (YES in step S515), the management server 10 obtains the log request information in step S516 and sends log list information to the user terminal 30 in step S517. The processing is then completed (END). If log request information is not sent from the user terminal 30 (NO in step S515), the management server 10 repeats step S515 until log request information is sent from the user terminal 30.

### (Procedure of Processing Executed by User Terminal)

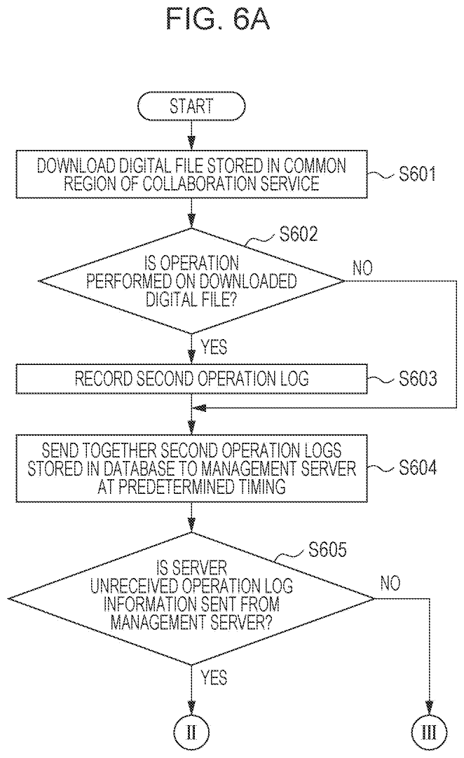

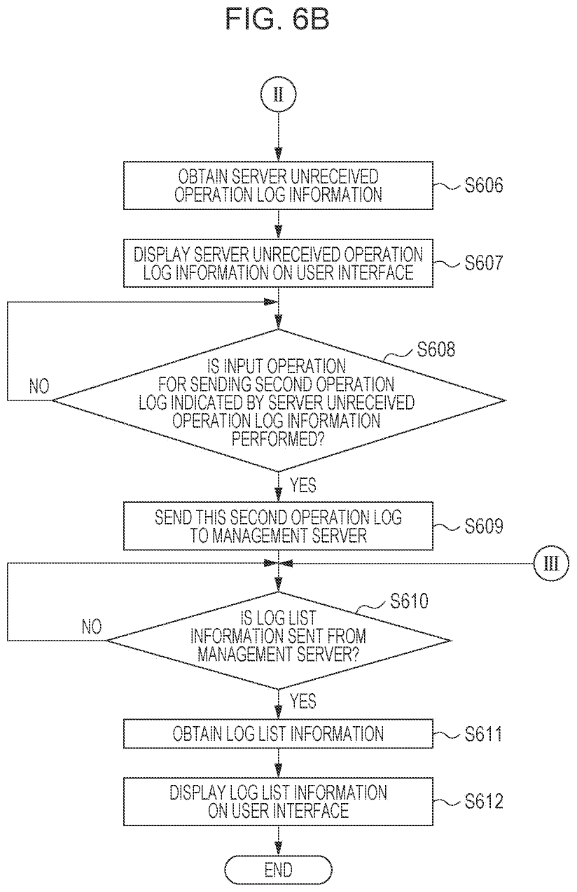

FIGS. 6A and 6B are a flowchart illustrating an example of a procedure of processing executed by the user terminal 30 from when a digital file is downloaded until log list information is displayed on a user interface.

In step S601, the user terminal 30 downloads a digital file stored in the common region of the collaboration service. If an operation is performed on the digital file (YES in step S602), the user terminal 30 records a second operation log in step S603. Then, in step S604, at a predetermined timing, the user terminal 30 sends together second operation logs stored in the database to the management server 10. More specifically, among the second operation logs stored in the database, the user terminal 30 sends the second operation logs that have not yet been sent. If an operation is not performed on the digital file (NO in step S602), the user terminal 30 proceeds to step S604.

If server unreceived operation log information is sent from the management server 10 (YES in step S605), the user terminal 30 obtains the server unreceived operation log information in step S606. Then, the user terminal 30 displays the obtained server unreceived operation log information on the user interface in step S607. If server unreceived operation log information is not sent from the management server 10 (NO in step S605), the user terminal 30 proceeds to step S610.

If an input operation for sending a second operation log indicated by the server unreceived operation log information is performed (YES in step S608), the user terminal 30 sends this second operation log to the management server 10 in step S609. If an input operation for sending a second operation log indicated by the server unreceived operation log information has not been performed (NO in step S608), the user terminal 30 repeats step S608 until such an input operation is performed or a timing when second operation logs are sent together has reached.

If log list information is sent from the management server 10 (YES in step S610), the user terminal 30 obtains the log list information in step S611. Then, in step S612, the user terminal 30 displays the log list information on the user interface. The processing is then completed (END). If log list information is not sent from the management server 10 (NO in step S610), the user terminal 30 repeats step S610 until log list information is sent from the management server 10.

### Specific Examples

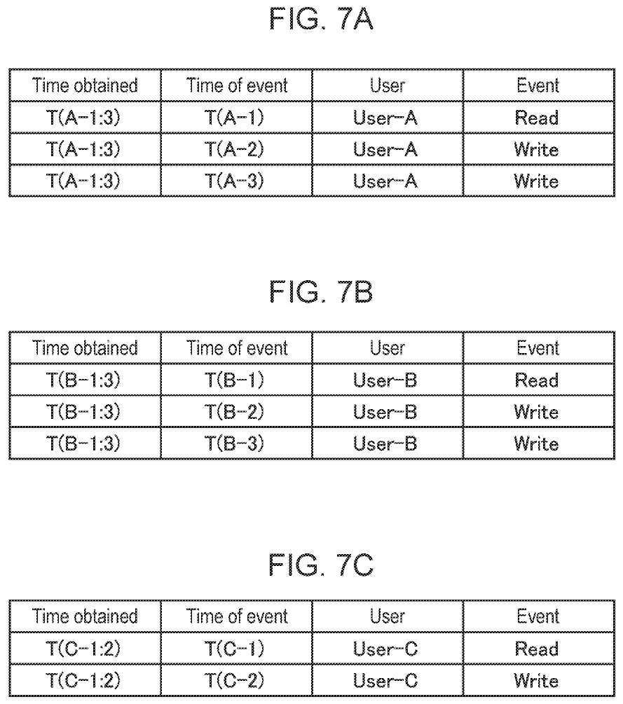

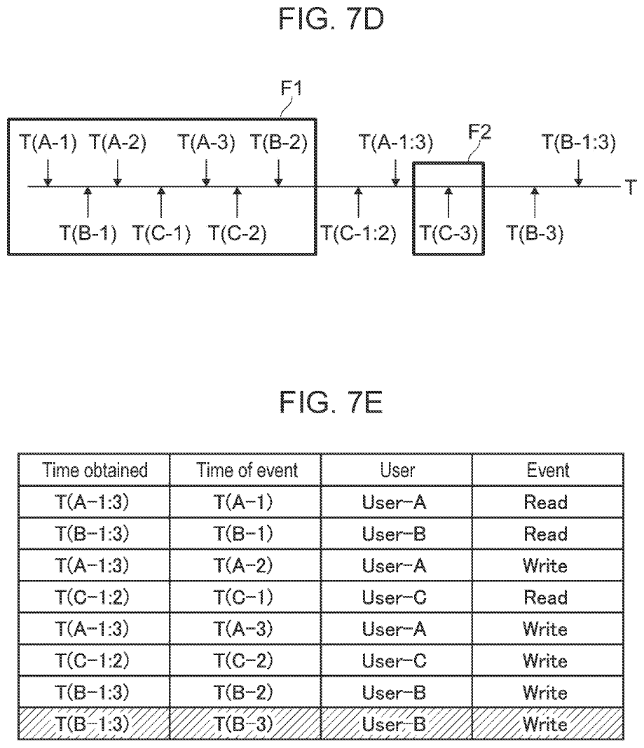

FIGS. 7A through 7E are diagrams for explaining a specific example of processing executed by the information processing system 1 shown in FIG. 1.

FIGS. 7A through 7C respectively illustrate the content of second operation logs obtained by the management server 10 (see FIG. 1) from the user terminals 30 of user A (User-A), user B (User-B), and user C (User-C). More specifically, as the content of second operation logs, plural items of information, such as “Time obtained” indicating the timing at which the management server 10 has obtained second operation logs, “Time of event” indicating the timing at which an event has occurred, “User” indicating a user having performed an operation related to an event, and “Event” indicating the content of an event, are associated with each other.

In FIGS. 7A through 13, (A-1) through (A-3), (B-1) through (B-3), and (C-1) through (C-3) are each alphanumeric characters for uniquely identifying an event. For example, (A-1) represents the first event having occurred in the user terminal 30 of user A (User-A). T(A-1) is alphanumeric characters representing the time, which is the timing at which the first event has occurred. (A-1:3) is alphanumeric characters representing the first through third events having occurred in the user terminal 30 of user A (User-A). T(A-1:3) is alphanumeric characters representing the timing at which the management server 10 has obtained the second operation logs associated with the first through third events.

FIG. 7A illustrates the content of the second operation logs obtained by the management server 10 from the user terminal 30 of user A (User-A). More specifically, the content of one second operation log shown in FIG. 7A is that “Time obtained” is T(A-1:3), “Time of event” is T(A-1), “User” is User-A, and “Event” is Read (View). The content of another second operation log shown in FIG. 7A is that “Time obtained” is T(A-1:3), “Time of event” is T(A-2), “User” is User-A, and “Event” is Write (Edit). The content of another second operation log shown in FIG. 7A is that “Time obtained” is T(A-1:3), “Time of event” is T(A-3), “User” is User-A, and “Event” is Write (Edit).

FIG. 7B illustrates the content of the second operation logs obtained by the management server 10 from the user terminal 30 of user B (User-B). More specifically, the content of one second operation log shown in FIG. 7B is that “Time obtained” is T(B-1:3), “Time of event” is T(B-1), “User” is User-B, and “Event” is Read (View). The content of another second operation log shown in FIG. 7B is that “Time obtained” is T(B-1:3), “Time of event” is T(B-2), “User” is User-B, and “Event” is Write (Edit). The content of another second operation log shown in FIG. 7B is that “Time obtained” is T(B-1:3), “Time of event” is T(B-3), “User” is User-B, and “Event” is Write (Edit).

FIG. 7C illustrates the content of the second operation logs obtained by the management server 10 from the user terminal 30 of user C (User-C). More specifically, the content of one second operation log shown in FIG. 7C is that “Time obtained” is T(C-1:2), “Time of event” is T(C-1), “User” is User-C, and “Event” is Read (View). The content of another second operation log shown in FIG. 7C is that “Time obtained” is T(C-1:2), “Time of event” is T(C-2), “User” is User-C, and “Event” is Write (Edit).

FIG. 7D shows a time axis T on which the timings when the events associated with the second operation logs have occurred and the timings when the management server 10 has obtained the second operation logs are visualized in chronological order. As illustrated in FIG. 7D, the chronological order of the timings when the events associated with the second operation logs have occurred and the timings when the management server 10 has obtained the second operation logs is T(A-1), T(B-1), T(A-2), T(C-1), T(A-3), T(C-2), T(B-2), T(C-1:2), T(A-1:3), T(C-3), T(B-3), and T(B-1:3).

In the example in FIGS. 7A through 7E, the chronological order of users from which the management server 10 has obtained the second operation logs is user C (User-C), user A (User-A), and user B (User-B). In the exemplary embodiment, events having occurred before the earliest timing (T(C-1:2)) of the times when the management server 10 has obtained the second operation logs are classified as operation logs which are chronologically fixed. More specifically, the events defined by the thick frame F1 in FIG. 7D are classified as operation logs which are chronologically fixed. In contrast, the second operation logs having occurred later than T(C-1:2) are classified as operation logs which are not chronologically fixed. More specifically, the event having occurred at the timing T(B-3) and the event (C-3) defined by the thick frame F2 are classified as operation logs which are not chronologically fixed. The meaning of the thick frame F2 will be explained later.

FIG. 7E illustrates a specific example of second operation logs displayed on the user interface of the user terminal 30 (see FIG. 1). More specifically, the second operation logs shown in FIGS. 7A through 7C are arranged in chronological order on the user interface in FIG. 7E. On the user interface, the operation logs which are chronologically fixed and the operation logs which are not chronologically fixed are displayed so that a user can distinguish the two types of operation logs from each other. For example, the two types of operation logs are displayed in a mode which allows a user to visually distinguish them from each other at first glance. In the example in FIG. 7E, the second operation log whose “Time obtained” is T(B-1:3), “Time of event” is T(B-3), “User” is User-B, and “Event” is “Write” (Edit) is shaded as an operation log which is not chronologically fixed, while the other second operation logs are displayed as operation logs which are chronologically fixed.

Among the multiple events visualized on the time axis T shown in FIG. 7D, the event (C-3) defined by the thick frame F2, that is, the event having occurred at the timing T(C-3), is not displayed on the user interface in FIG. 7E. This is because the event (C-3) is not recorded in the management server 10 for some reason. Examples of the reason why the event (C-3) is not recorded in the management server 10 are that the second operation log associated with the event (C-3) has not been sent from the user terminal 30 to the management server 10 due to a communication failure or a hardware problem, for example, and that the second operation log associated with the event (C-3) has been sent from the user terminal 30 to the management server 10 but is not received by the management server 10.

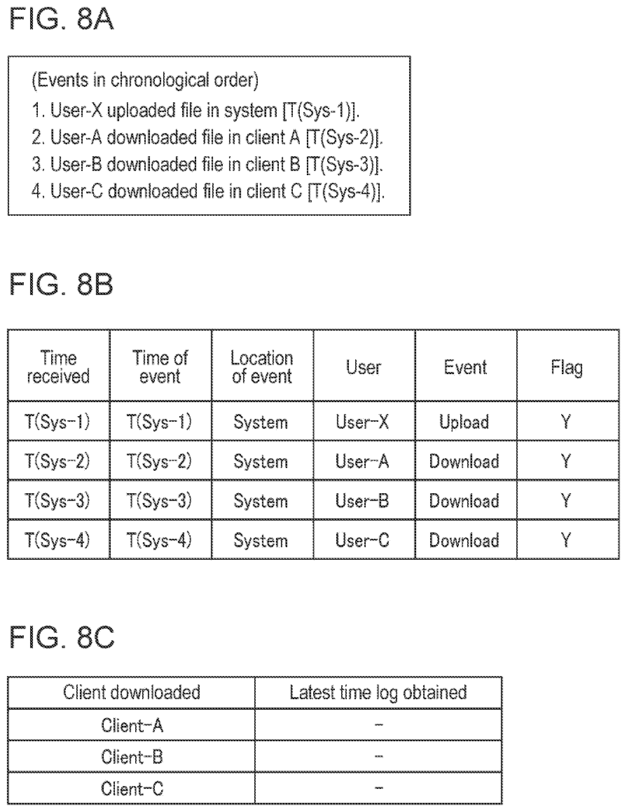

FIGS. 8A through 12F are diagrams for explaining a detailed procedure of the processing shown in FIGS. 7A through 7E. (Sys-1) through (Sys-4) are each alphanumeric characters for uniquely identifying an event having occurred in the common region of the management server 10 (System). T(Sys-1) through T(Sys-4) are alphanumeric characters respectively representing the times (timings) at which the first through fourth events have occurred and the times (timings) at which the management server 10 has received a first operation log.

For example, (Sys-1) represents the first event having occurred in the common region of the management server 10 (System) as a result of the user terminal 30 of user X (User-X) having accessed the management server 10. T(Sys-1) represents the time (timing) at which the first event has occurred and is also the time (timing) at which the management server 10 has received the first operation log associated with the first event.

FIG. 8A shows the contents and the times of events in chronological order, and more specifically, the contents of the first through fourth events and the times when the first through fourth events have occurred in the common region of the management server 10. The content of the first event indicates that user X (User-X) has uploaded a file in the common region (system) of the management server 10. The time (timing) at which the first event has occurred is T(Sys-1). The content of the second event indicates that user A (User-A) has downloaded the file from the common region (system) of the management server 10 into the user terminal 30 (client A) of user A. The time (timing) at which the second event has occurred is T(Sys-2).

The content of the third event indicates that user B (User-B) has downloaded the file from the common region (system) of the management server 10 into the user terminal 30 (client B) of user B. The time (timing) at which the third event has occurred is T(Sys-3). The content of the fourth event indicates that user C (User-C) has downloaded the file from the common region (system) of the management server 10 into the user terminal 30 (client C) of user C. The time (timing) at which the fourth event has occurred is T(Sys-4).

FIG. 8B illustrates an example of a database (such as the log DB 132 shown in FIG. 2) in which the operation logs associated with the first through fourth events shown in FIG. 8A are recorded. In this database, “Time received” indicating the timing at which the management server 10 has obtained an operation log, “Time of event” indicating the timing at which an event has occurred, “Location of event” indicating a location where an event has occurred, “User” indicating the user having performed an operation related to an event, “Event” indicating the content of an event, and “Flag” indicating whether an operation log is an operation log which is chronologically fixed or an operation log which is not chronologically fixed are associated with each other.

For example, the first operation log associated with the first event whose “Time received” and “Time of event” is T(Sys-1), “Location of event” is System (the common region of the management server 10), “User” is User-X (user X), “Event” is Upload, and “Flag” is Y (fixed) is shown. The first operation log associated with the second event whose “Time received” and “Time of event” is T(Sys-2), “Location of event” is System (the common region of the management server 10), “User” is User-A (user A), “Event” is Download, and “Flag” is Y (fixed) is also shown.

The first operation log associated with the third event whose “Time received” and “Time of event” is T(Sys-3), “Location of event” is System (the common region of the management server 10), “User” is User-B (user B), “Event” is Download, and “Flag” is Y (fixed) is also shown. The first operation log associated with the fourth event whose “Time received” and “Time of event” is T(Sys-4), “Location of event” is System (the common region of the management server 10), “User” is User-C (user C), “Event” is Download, and “Flag” is Y (fixed) is also shown.

FIG. 8C illustrates an example of a database (such as the log DB 132 shown in FIG. 2) in which the time when the management server 10 has most recently obtained second operation logs is recorded for each user terminal 30. In this database, “Client downloaded” indicating the user of the user terminal 30 having sent second operation logs to the management server 10 and “Latest time log obtained” indicating the timing at which the management server 10 has most recently obtained second operation logs are associated with each other. Since, as shown in FIG. 8A, the first through fourth events are not events in which the management server 10 obtains second operation logs, “Latest time log obtained” in FIG. 8C indicate “-” (not recorded).

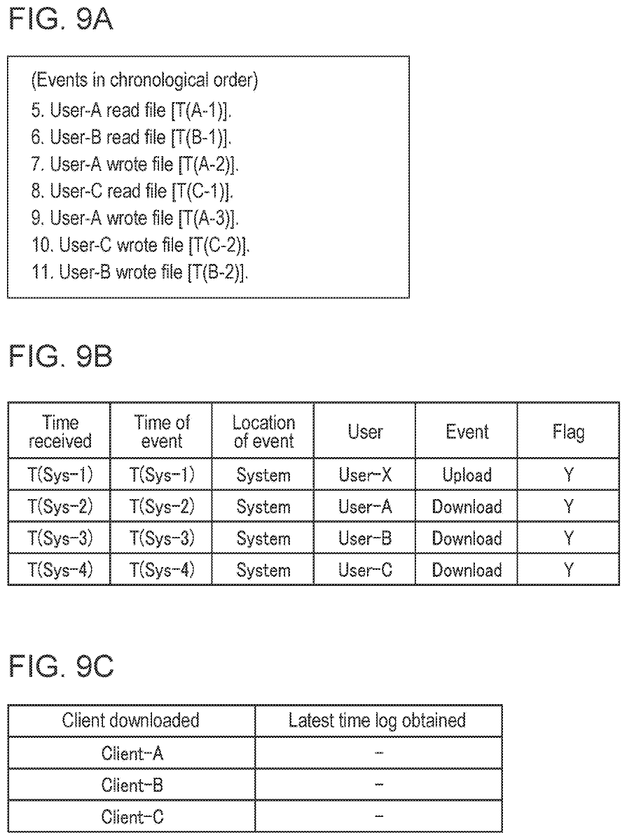

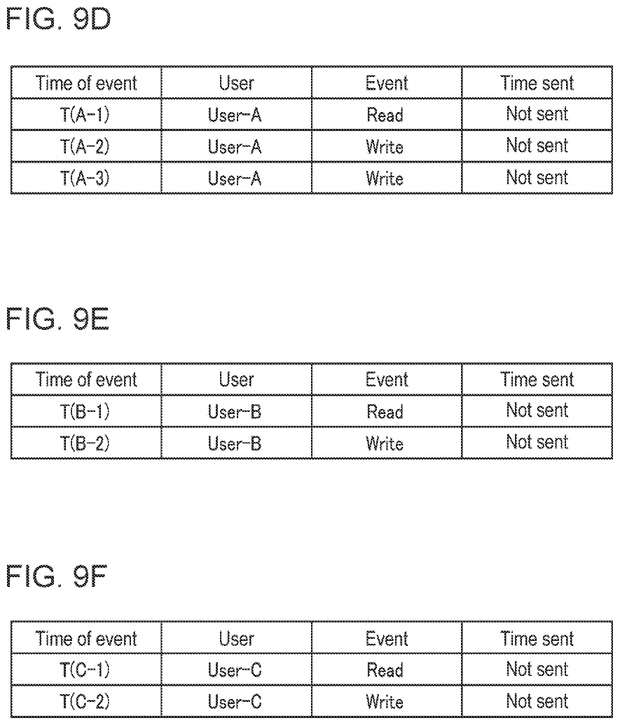

FIG. 9A shows the contents and the times of events in chronological order, and more specifically, the contents of the fifth through eleventh events and the times when the fifth through eleventh events have occurred in the user terminal 30. The content of the fifth event indicates that user A (User-A) has read (viewed) the file by operating the user terminal 30. The time (timing) at which the fifth event has occurred is T(A-1). The content of the sixth event indicates that user B (User-B) has read (viewed) the file by operating the user terminal 30. The time (timing) at which the sixth event has occurred is T(B-1).

The content of the seventh event indicates that user A (User-A) has written (edited) the file by operating the user terminal 30. The time (timing) at which the seventh event has occurred is T(A-2). The content of the eighth event indicates that user C (User-C) has read (viewed) the file by operating the user terminal 30. The time (timing) at which the eighth event has occurred is T(C-1). The content of the ninth event indicates that user A (User-A) has written (edited) the file by operating the user terminal 30. The time (timing) at which the ninth event has occurred is T(A-3).

The content of the tenth event indicates that user C (User-C) has written (edited) the file by operating the user terminal 30. The time (timing) at which the tenth event has occurred is T(C-2). The content of the eleventh event indicates that user B (User-B) has written (edited) the file by operating the user terminal 30. The time (timing) at which the eleventh event has occurred is T(B-2).

FIG. 9B illustrates an example of a database (such as the log DB 132 shown in FIG. 2) in which the operation logs associated with the first through eleventh events shown in FIGS. 8A and 9A are recorded. Since, as shown in FIG. 9A, all of the fifth through eleventh events have occurred in the user terminal 30, no operation log is added. Hence, the content of the database in FIG. 9B is the same as that in FIG. 8B.

FIG. 9C illustrates an example of a database (such as the log DB 132 shown in FIG. 2) in which the time when the management server 10 has most recently obtained second operation logs is recorded for each user terminal 30. As shown in FIG. 9A, the fifth through eleventh events are not events in which the management server 10 obtains second operation logs. Hence, the content of the database in FIG. 9C is the same as that in FIG. 8C.

FIGS. 9D through 9F illustrate examples of second operation logs recorded in the databases of the storages of the user terminals 30. In FIG. 9D, the second operation logs recorded in the database of the storage of the user terminal 30 of user A (User-A) are shown. More specifically, in FIG. 9D, the second operation log associated with the fifth event whose “Time of event” indicating the timing at which an event has occurred in the user terminal 30 is T(A-1), “User” is User-A, “Event” is Read (View), and “Time sent” to the management server 10 is “Not sent” is shown.

In FIG. 9D, the second operation log associated with the seventh event whose “Time of event” is T(A-2), “User” is User-A, “Event” is Write (Edit), and “Time sent” to the management server 10 is “Not sent” is also shown. The second operation log associated with the ninth event whose “Time of event” is T(A-3), “User” is User-A, “Event” is Write (Edit), and “Time sent” to the management server 10 is “Not sent” is also shown. That is, FIG. 9D shows that three second operation logs are stored in the user terminal 30 of user A (User-A) and none of them is sent to the management server 10.

In FIG. 9E, the second operation logs recorded in the database of the storage of the user terminal 30 of user B (User-B) are shown. More specifically, in FIG. 9E, the second operation log associated with the sixth event whose “Time of event” is T(B-1), “User” is User-B, “Event” is Read (View), and “Time sent” to the management server 10 is “Not sent” is shown. In FIG. 9E, the second operation log associated with the eleventh event whose “Time of event” is T(B-2), “User” is User-B, “Event” is Write (Edit), and “Time sent” to the management server 10 is “Not sent” is also shown. That is, FIG. 9E shows that two second operation logs are stored in the user terminal 30 of user B (User-B) and neither of them is sent to the management server 10.

In FIG. 9F, the second operation logs recorded in the database of the storage of the user terminal 30 of user C (User-C) are shown. More specifically, in FIG. 9F, the second operation log associated with the eighth event whose “Time of event” is T(C-1), “User” is User-C, “Event” is Read (View), and “Time sent” to the management server 10 is “Not sent” is shown. In FIG. 9F, the second operation log associated with the tenth event whose “Time of event” is T(C-2), “User” is User-C, “Event” is Write (Edit), and “Time sent” to the management server 10 is “Not sent” is also shown. That is, FIG. 9F shows that two second operation logs are stored in the user terminal 30 of user C (User-C) and neither of them is sent to the management server 10.

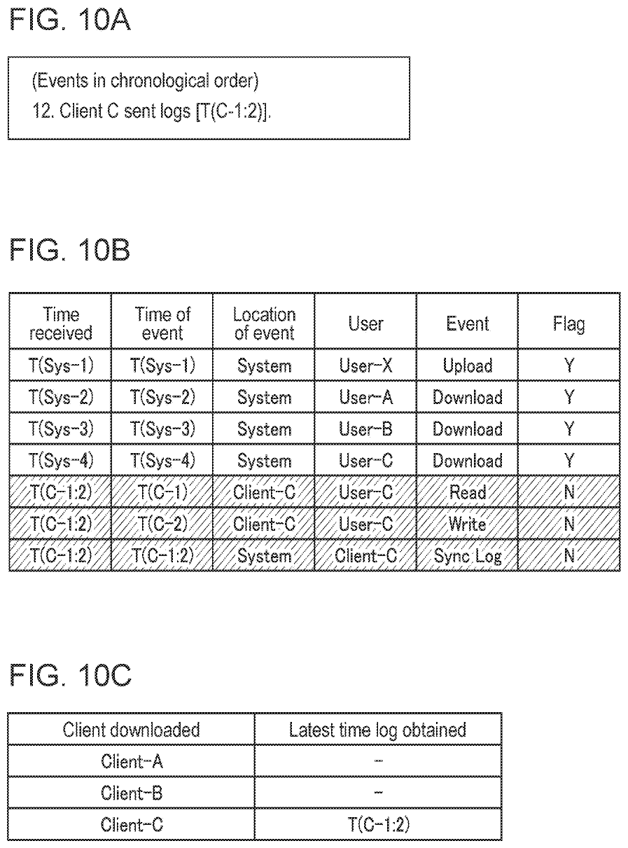

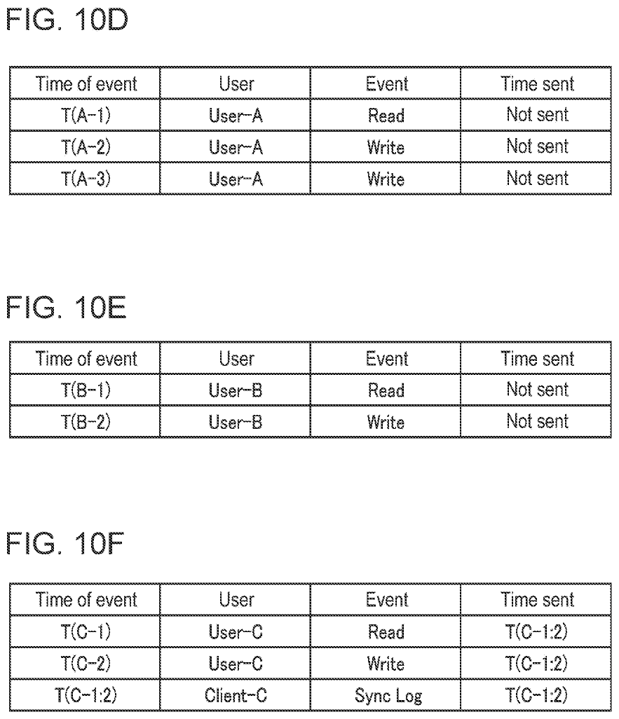

FIG. 10A shows the content of the twelfth event and the time when the twelfth event has occurred in the user terminal 30. The content of the twelfth event indicates that second operation logs are sent from the user terminal 30 (client C) of user C (User-C) to the management server 10. The time (timing) at which the twelfth event has occurred is T(C-1:2).

FIG. 10B illustrates an example of a database (such as the log DB 132 shown in FIG. 2) in which the operation logs associated with the first through twelfth events shown in FIGS. 8A, 9A, and 10A are recorded. The twelfth event is an event in which the management server 10 has obtained second operation logs. Hence, among the operation logs shown in FIG. 10B, two operation logs whose “Location of event” is Client-C are operation logs obtained by the management server 10 as a result of the two operation logs shown in FIG. 9F being sent to the management server 10. “Flag” of each of the two second operation logs is N (not fixed).

Among the operation logs shown in FIG. 10B, the operation log whose “Location of event” is System and “User” is Client-C is the first operation log corresponding to “Sync Log” (synchronization). That is, this operation log is the first operation log associated with the event in which the management server 10 has obtained second operation logs sent from the user terminal 30 of user C (User-C). “Flag” of this operation log is N (not fixed).

As in FIG. 9C, FIG. 10C illustrates an example of a database (such as the log DB 132 shown in FIG. 2) in which the time when the management server 10 has most recently obtained second operation logs is recorded for each user terminal 30. As shown in FIG. 10A, the twelfth event is an event in which the management server 10 has obtained second operation logs. The database in FIG. 10C thus shows that “Latest time log obtained” when the management server 10 has most recently obtained the second operation logs sent from Client-C, which is the user terminal 30 of user C (User-C), is T(C-1:2).

FIG. 10D illustrates second operation logs recorded in the database of the storage of the user terminal 30 of user A (User-A). As shown in FIG. 10A, the twelfth event is an event related to the user terminal 30 of user C (User-C) and is not an event related to the user terminal 30 of user A (User-A). Accordingly, the content of the database in FIG. 10D is the same as that in FIG. 9D.

FIG. 10E illustrates second operation logs recorded in the database of the storage of the user terminal 30 of user B (User-B). As shown in FIG. 10A, the twelfth event is an event related to the user terminal 30 of user C (User-C) and is not an event related to the user terminal 30 of user B (User-B). Accordingly, the content of the database in FIG. 10E is the same as that in FIG. 9E.

FIG. 10F illustrates second operation logs recorded in the database of the storage of the user terminal 30 of user C (User-C). As shown in FIG. 10A, the twelfth event is an event related to the user terminal 30 of user C (User-C). The content of the database in FIG. 10F is thus changed from that shown in FIG. 9F. More specifically, in the database in FIG. 10F, “Time sent” of each of the events (C-1) and (C-2) is changed to T(C-1:2) and the second operation log whose “Event” is Sync Log is added. That is, the event in which the second operation logs associated with the events (C-1) and (C-2) have been sent from the user terminal 30 to the management server 10 is recorded in the database in FIG. 10F.

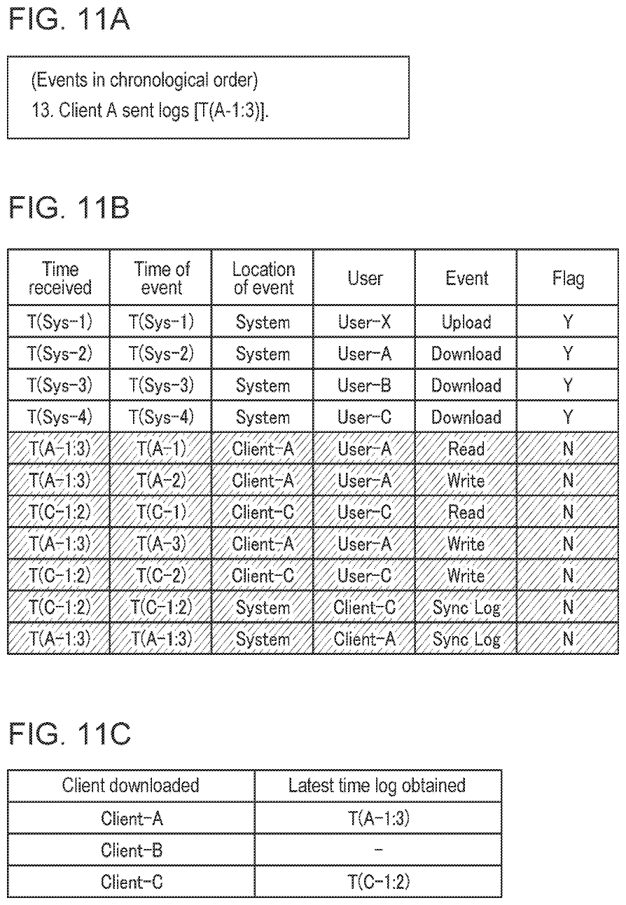

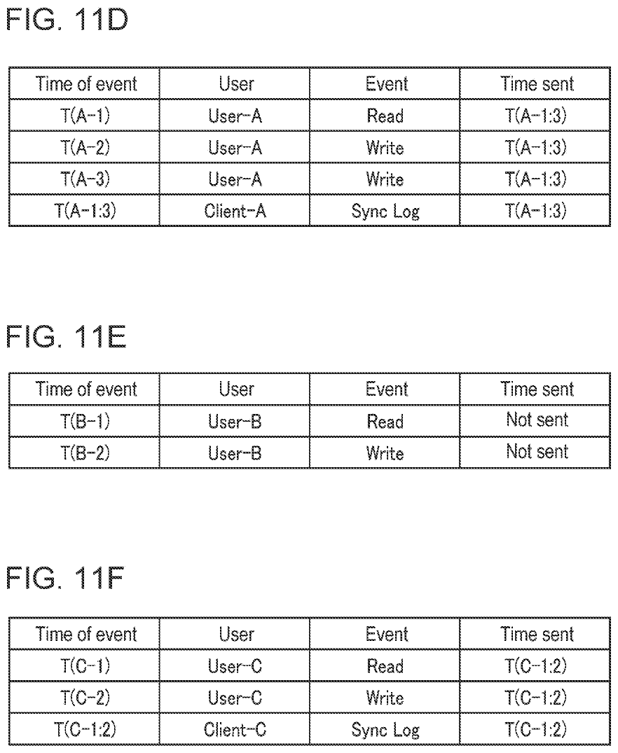

FIG. 11A shows the content of the thirteenth event and the time when the thirteenth event has occurred in the user terminal 30. The content of the thirteenth event indicates that second operation logs are sent from the user terminal 30 (client A) of user A (User-A) to the management server 10. The time (timing) at which the thirteenth event has occurred is T(A-1:3).

FIG. 11B illustrates an example of a database (such as the log DB 132 shown in FIG. 2) in which the operation logs associated with the first through thirteenth events shown in FIGS. 8A, 9A, 10A, and 11A are recorded. The thirteenth event is an event in which the management server 10 has obtained second operation logs. Hence, among the operation logs shown in FIG. 11B, three operation logs whose “Location of event” is Client-A are all operation logs obtained by the management server 10 as a result of the three operation logs shown in FIG. 10D being sent to the management server 10. “Flag” of each of the three second operation logs is N (not fixed).

Among the operation logs shown in FIG. 11B, the operation log whose “Location of event” is System, “User” is Client-A, and “Event” is Sync Log (synchronization) is a first operation log. That is, this operation log is the first operation log associated with the event in which the management server 10 has obtained second operation logs sent from the user terminal of user A (User-A). “Flag” of this operation log is N (not fixed).

As in FIG. 10C, FIG. 11C illustrates an example of a database (such as the log DB 132 shown in FIG. 2) in which the time when the management server 10 has most recently obtained second operation logs is recorded for each user terminal 30. As shown in FIG. 11A, the thirteenth event is an event in which the management server 10 has obtained second operation logs from client A (Client-A), which is the user terminal 30 of user A. The database in FIG. 11C thus shows that “Latest time log obtained” when the management server 10 has most recently obtained the second operation logs sent from client A (Client-A) is T(A-1:3) and “Latest time log obtained” when the management server 10 has most recently obtained the second operation logs sent from client C (Client-C), which is the user terminal 30 of user C (User-C), is T(C-1:2).

FIG. 11D illustrates second operation logs recorded in the database of the storage of the user terminal 30 of user A (User-A). As shown in FIG. 11A, the thirteenth event is an event related to the user terminal 30 of user A (User-A). The content of the database in FIG. 11D is thus changed from that shown in FIG. 10D. More specifically, in the database in FIG. 11D, “Time sent” of each of the events (A-1) through (A-3) is changed to T(A-1:3) and the second operation log whose “Event” is Sync Log is added. That is, the event in which the second operation logs associated with the events (A-1) through (A-3) have been sent from the user terminal 30 to the management server 10 is recorded in the database in FIG. 11D.

FIG. 11E illustrates second operation logs recorded in the database of the storage of the user terminal 30 of user B (User-B). As shown in FIG. 11A, the thirteenth event is an event related to the user terminal 30 of user A (User-A) and is not an event related to the user terminal 30 of user B (User-B). Accordingly, the content of the database in FIG. 11E is the same as that in FIG. 10E.

FIG. 11F illustrates second operation logs recorded in the database of the storage of the user terminal 30 of user C (User-C). As shown in FIG. 11A, the thirteenth event is an event related to the user terminal 30 of user A (User-A) and is not an event related to the user terminal 30 of user C (User-C). Accordingly, the content of the database in FIG. 11F is the same as that in FIG. 10F.

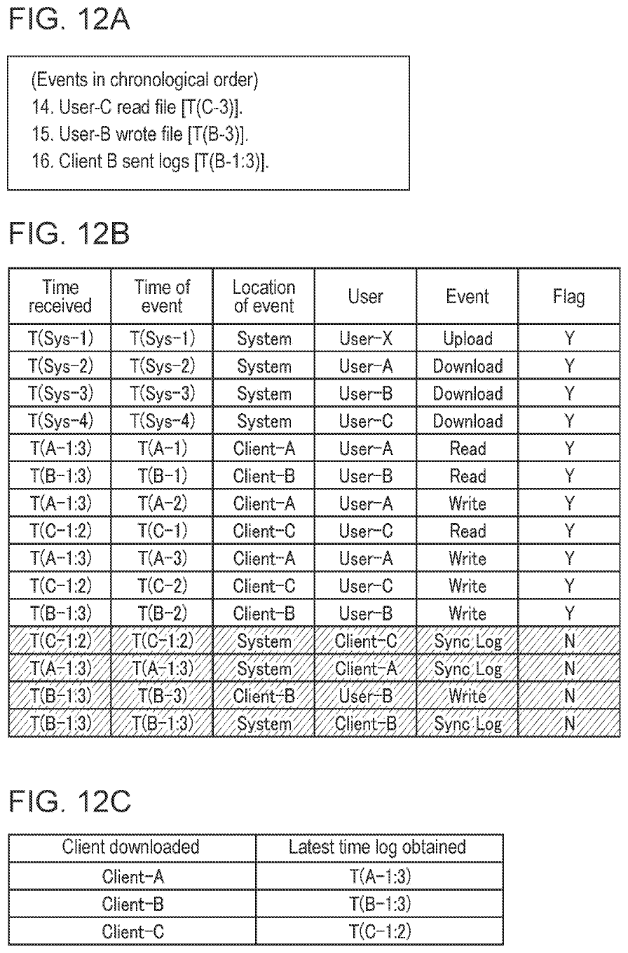

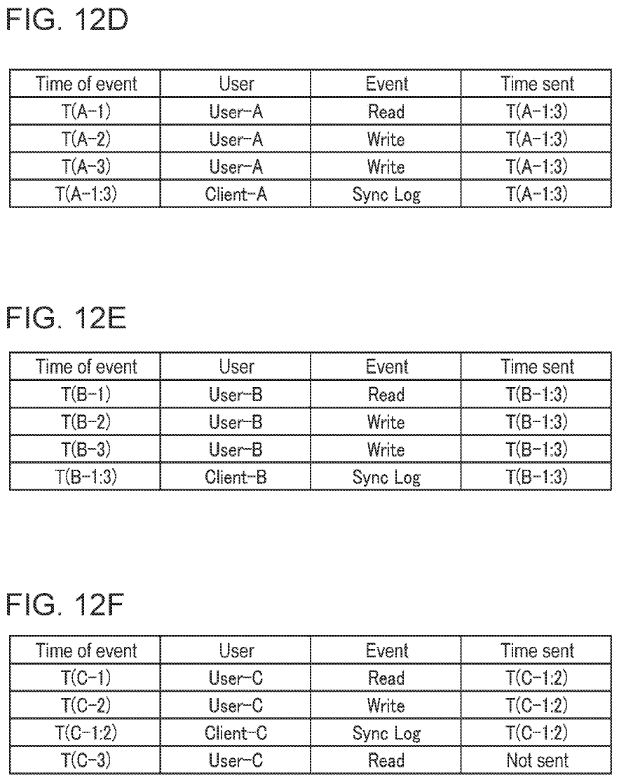

FIG. 12A shows the contents of the fourteenth through sixteenth events and the times when the fourteenth through sixteenth events have occurred in the user terminal 30. The content of the fourteenth event indicates that user C (User-C) has read (viewed) the file by operating the user terminal 30. The time (timing) at which the fourteenth event has occurred is T(C-3). The content of the fifteenth event indicates that user B (User-B) has written (edited) the file by operating the user terminal 30. The time (timing) at which the fifteenth event has occurred is T(B-3). The content of the sixteenth event indicates that second operation logs are sent from the user terminal 30 (client B) of user B (User-B) to the management server 10. The time (timing) at which the sixteenth event has occurred is T(B-1:3).

FIG. 12B illustrates an example of a database (such as the log DB 132 shown in FIG. 2) in which the first and second operation logs associated with the first through sixteenth events shown in FIGS. 8A, 9A, 10A, 11A, and 12A are recorded. Among the operation logs shown in FIG. 12B, the operation log whose “Time received” is T(B-1:3), “Time of event” is T(B-1), and “Location of event” is Client-B, the operation log whose “Time received” is T(B-1:3), “Time of event” is T(B-2), and “Location of event” is Client-B, the operation log whose “Time received” is T(B-1:3), “Time of event” is T(B-3), and “Location of event” is Client-B, and the operation log whose “Time received” and “Time of event” are T(B-1:3) and “Location of event” is System are those added by the fifteenth and sixteenth events.

The content of the fifteenth event indicates that user B (User-B) has written (edited) the file by operating the user terminal 30. The time (timing) at which the fifteenth event has occurred is T(B-3). The content of the sixteenth event indicates that the management server 10 has obtained second operation logs sent from client B (Client-B). Among the operation logs in FIG. 12B, “Flag” of each of the shaded operation logs is N (not fixed).

As in FIG. 11C, FIG. 12C illustrates an example of a database (such as the log DB 132 shown in FIG. 2) in which the time when the management server 10 has most recently obtained second operation logs is recorded for each user terminal 30. As shown in FIG. 12A, the sixteenth event is an event in which the management server 10 has obtained second operation logs from client B (Client-B), which is the user terminal 30 of user B. The database in FIG. 12C thus shows that “Latest time log obtained” when the management server 10 has most recently obtained the second operation logs sent from client B (Client-B) is T(B-1:3).

The database in FIG. 12C also shows that “Latest time log obtained” when the management server 10 has most recently obtained the second operation logs sent from client A (Client-A), which is the user terminal 30 of user A (User-A), is T(A-1:3) and that “Latest time log obtained” when the management server 10 has most recently obtained the second operation logs sent from client C (Client-C), which is the user terminal 30 of user C (User-C), is T(C-1:2).

FIG. 12D illustrates second operation logs recorded in the database of the storage of the user terminal 30 of user A (User-A). As shown in FIG. 12A, none of the fourteenth through sixteenth events is an event related to the user terminal 30 of user A (User-A). Accordingly, the content of the database in FIG. 12D is the same as that in FIG. 11D.

FIG. 12E illustrates second operation logs recorded in the database of the storage of the user terminal 30 of user B (User-B). As shown in FIG. 12A, the fifteenth and sixteenth events are events related to the user terminal 30 of user B (User-B). The content of the database in FIG. 12E is thus changed from that shown in FIG. 11E. More specifically, in the database in FIG. 12E, the second operation log whose “Time of event” is T(B-3), “User” is user B (User-B), “Event” is Write, and “Time sent” is T(B-1:3) is added.

In the database in FIG. 12E, “Time sent” of each of the events (B-1) and (B-2) is changed to T(B-1:3) and the second operation log whose “Event” is Sync Log is added. That is, the event in which the second operation logs associated with the events (B-1) through (B-3) have been sent from the user terminal 30 to the management server 10 is recorded in the database in FIG. 12E.

FIG. 12F illustrates second operation logs recorded in the database of the storage of the user terminal 30 of user C (User-C). As shown in FIG. 12A, the fourteenth event is an event related to the user terminal 30 of user C (User-C). The content of the database in FIG. 12F is thus changed from that shown in FIG. 11F. More specifically, in the database in FIG. 12F, the second operation log whose “Time of event” is T(C-3), “User” is user C (User-C), “Event” is Read, and “Time sent” is “Not sent” is added. This second operation log is not recorded in the database in FIG. 12B since “Time sent” is “Not sent”.

FIG. 13 illustrates a specific example of log list information displayed on the display of the user terminal 30 to allow a user to distinguish operation logs which are chronologically fixed and operation logs which are not chronologically fixed from each other.

When the management server 10 has classified operation logs into those which are chronologically fixed and those which are not chronologically fixed, a list, such as that shown in FIG. 13, is generated as information for allowing a user to identify the classification result. The generated list is displayed on the display of the user terminal 30, based on log request information. This list includes various items of information, such as “Time received” indicating the timing at which the management server 10 has received a first or second operation log, “Time of event” indicating the timing at which an event associated with a first or second operation log has occurred, “Location of event” indicating the location where an event has occurred, “User” indicating a user having performed operation or processing related to an event, and “Event” indicating the content of an event.

In the list shown in FIG. 13, the operation logs which are chronologically fixed are not shaded, while the operation log which is not chronologically fixed is shaded. A user can thus identify the classification result at first glance. More specifically, the operation log whose “Time received” is T(B-1:3), “Time of event” is T(B-3), “Location of event” is Client-B, “User” is User-B, and “Event” is Write is shaded, while the other operation logs are not shaded. The second operation log whose “Time sent” is “Not sent” shown in FIG. 12F is not included in the list in FIG. 13.

### Other Exemplary Embodiments

The exemplary embodiment has been described above, but the disclosure is not limited thereto. For example, the configuration of the information processing system 1 shown in FIG. 1 and the hardware configuration of the management server 10 shown in FIG. 2 are only examples, and the configurations of the information processing system 1 and the management server 10 are not restricted to particular configurations. The functional configuration of the management server 10 shown in FIG. 3 and that of the user terminal 30 shown in FIG. 4 are also only examples, and functional configurations of the management server 10 and the user terminal 30 are not restricted to particular configurations. The information processing system 1 may be configured in any manner if it has functions that implement the above-described processing operations as a whole. The functional configuration of the management server 10 and that of the user terminal 30 that implement these functions are not restricted to the configurations shown in FIGS. 3 and 4.

The order of steps executed by the management server 10 shown in FIGS. 5A and 5B and that of the user terminal 30 shown in FIGS. 6A and 6B are only examples, and the order of operations of the management server 10 and that of the user terminal 30 are not restricted to particular orders. The operations may not necessarily be executed in chronological order as shown in FIGS. 5A through 6B and may be executed in parallel or individually. Specific examples shown in FIG. 7A through 13 are also only examples.

For instance, in the example in FIG. 13, operation logs which are chronologically fixed and operation logs which are not chronologically fixed are distinguished from each other according to whether they are shaded. The two types of operation logs may be distinguished from each other in a different manner. For example, the two types of operation logs may be distinguished from each other by the difference in color or in the thickness of characters.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
at least one processor configured to:
   obtain, as log information of an operation performed on a digital file stored in a common region of a server, a first operation log recorded in the server and a second operation log which is recorded in a client device having downloaded the digital file and which is sent from the client device; and
   classify each of the obtained first operation log and second operation log as an operation log which is chronologically fixed or as an operation log which is not chronologically fixed, based on a recording time at which each of the first and second operation logs is recorded and a time at which the second operation log is obtained.
      (((2)))

The information processing system according to (((1))), wherein the at least one processor is configured to obtain one or more second operation logs which has not or have not yet been sent to the server, the one or more second operation logs being sent together from the client device at a predetermined timing.

(((3)))

The information processing system according to (((2))), wherein the at least one processor is configured to:
identify, for each client device, a latest time at which second operation logs have been obtained, and specify an earliest time among the identified latest times, based on content of each of the second operation logs; and
classify, among the obtained first operation logs and second operation logs, an operation log whose recording time is earlier than the specified earliest time as an operation log which is chronologically fixed and an operation log whose recording time is later than the specified earliest time as an operation log which is not chronologically fixed.
   (((4)))

The information processing system according to (((2))) or (((3))), wherein the at least one processor is configured not to classify a second operation log which has not been obtained at the predetermined timing among the second operation logs stored in a predetermined client device.

(((5)))

The information processing system according to (((4))), wherein the predetermined client device is a client device that has downloaded the digital file.

(((6)))

The information processing system according to (((4))) or (((5))), wherein, if the predetermined client device has not performed an operation on the digital file, the second operation log sent from the predetermined client device includes log information indicating that an operation has not been performed on the digital file.

(((7)))

The information processing system according to any one of (((4))) to (((6))), wherein the at least one processor is configured to perform control to inform a user of the predetermined client device of presence of the second operation log which has not been obtained.

(((8)))

The information processing system according to (((7))), wherein the at least one processor is configured to request the predetermined client device to send the second operation log which has not been obtained.

(((9)))

The information processing system according to any one of (((1))) to (((8))), wherein the at least one processor is configured to perform control to present information to a user so as to allow the user to distinguish the operation log which is chronologically fixed and the operation log which is not chronologically fixed from each other.

(((10)))

The information processing system according to (((9))), wherein the at least one processor is configured to present, as the information, information showing that, on a list including the operation log which is chronologically fixed and the operation log which is not chronologically fixed, an external appearance of the operation log which is chronologically fixed and an external appearance of the operation log which is not chronologically fixed are different from each other.

(((11)))

An information processing apparatus comprising:
a processor configured to:
   record, as an operation log, log information of an operation performed on a digital file downloaded from a common region of a server;
   perform control to send together to the server at a predetermined timing, one or more operation logs that has not or have not yet been sent to the server among the recorded operation logs; and
   perform control to send to the server at the predetermined timing, as the operation log, if an operation has not been performed on the digital file, log information indicating that an operation has not been performed on the digital file.
      (((12)))

A program for causing a computer to implement:
a function of obtaining, as log information of an operation performed on a digital file stored in a common region of a server, a first operation log recorded in the server and a second operation log which is recorded in a client device having downloaded the digital file and which is sent from the client device; and
a function of classifying each of the obtained first operation log and second operation log as an operation log which is chronologically fixed or as an operation log which is not chronologically fixed, based on a recording time at which each of the first and second operation logs is recorded and a time at which the second operation log is obtained.
   (((13)))

A program for causing a computer to implement:
a function of recording, as an operation log, log information of an operation performed on a digital file downloaded from a common region of a server;
a function of performing control to send together to the server at a predetermined timing, one or more operation logs that has not or have not yet been sent to the server among the recorded operation logs; and
a function of performing control to send to the server at the predetermined timing, as the operation log, if an operation has not been performed on the digital file, log information indicating that an operation has not been performed on the digital file.

What is claimed is:

1. An information processing apparatus comprising:
a processor configured to:
obtain, as log information of an operation performed on a digital file stored in a common region of the information processing apparatus, a first operation log recorded in the information processing apparatus and a second operation log recorded in a client device which has downloaded the digital file; and
classify each of the obtained first operation log and second operation log as an operation log which is chronologically fixed or as an operation log which is not chronologically fixed, based on a recording time at which each of the first and second operation logs is recorded and a time at which the second operation log is obtained.

2. The information processing apparatus according to claim 1, wherein the processor is configured to obtain one or more second operation logs which has not or have not yet been sent to the information processing apparatus, the one or more second operation logs being sent together from the client device at a predetermined timing.

3. The information processing apparatus according to claim 2, wherein the processor is configured to:
identify, for each client device, a latest time at which second operation logs have been obtained, and specify an earliest time among the identified latest times, based on content of each of the second operation logs; and
classify, among the obtained first operation logs and second operation logs, an operation log whose recording time is earlier than the specified earliest time as an operation log which is chronologically fixed and an operation log whose recording time is later than the specified earliest time as an operation log which is not chronologically fixed.

4. The information processing apparatus according to claim 3, wherein the processor is configured not to classify a second operation log which has not been obtained at the predetermined timing among the second operation logs stored in a predetermined client device.

5. The information processing apparatus according to claim 4, wherein the predetermined client device is a client device that has downloaded the digital file.

6. The information processing apparatus according to claim 4, wherein, if the predetermined client device has not performed an operation on the digital file, the second operation log sent from the predetermined client device includes log information indicating that an operation has not been performed on the digital file.

7. The information processing apparatus according to claim 4, wherein the processor is configured to perform control to inform a user of the predetermined client device of presence of the second operation log which has not been obtained.

8. The information processing apparatus according to claim 7, wherein the processor is configured to request the predetermined client device to send the second operation log which has not been obtained.

9. The information processing apparatus according to claim 1, wherein the processor is configured to perform control to present information to a user so as to allow the user to distinguish the operation log which is chronologically fixed and the operation log which is not chronologically fixed from each other.

10. The information processing apparatus according to claim 9, wherein the processor is configured to present, as the information, information showing that, on a list including the operation log which is chronologically fixed and the operation log which is not chronologically fixed, an external appearance of the operation log which is chronologically fixed and an external appearance of the operation log which is not chronologically fixed are different from each other.

11. An information processing apparatus comprising:
a processor configured to:
record, as an operation log, log information of an operation performed on a digital file downloaded from a common region of a server;
perform control to send together to the server at a predetermined timing, one or more operation logs that has not or have not yet been sent to the server among the recorded operation logs; and
perform control to send to the server at the predetermined timing, as the operation log, if an operation has not been performed on the digital file, log information indicating that an operation has not been performed on the digital file.

12. A non-transitory computer readable medium storing a program causing a computer to execute a process, the process comprising:
obtaining, as log information of an operation performed on a digital file stored in a common region of an information processing apparatus, a first operation log recorded in the information processing apparatus and a second operation log recorded in a client device which has downloaded the digital file; and
classifying each of the obtained first operation log and second operation log as an operation log which is chronologically fixed or as an operation log which is not chronologically fixed, based on a recording time at which each of the first and second operation logs is recorded and a time at which the second operation log is obtained.
